(19) United States
(12) Patent Application Publication
(10) Pub. No.: US 2022/0066483 A1
(43) Pub. Date: Mar. 3, 2022

(54) A Vibration Control System and Related Methods

(71) Applicant: AGENCY FOR SCIENCE, TECHNOLOGY AND RESEARCH, Singapore (SG)

(72) Inventors: Rogerio Salloum, Singapore (SG); Szu Cheng Lai, Singapore (SG); Kui Yao, Singapore (SG)

(21) Appl. No.: 17/419,765

(22) PCT Filed: Mar. 10, 2020
(86) PCT No.: PCT/SG2020/050120

§ 371 Date: Jun. 30, 2021

(30) Foreign Application Priority Data
Mar. 14, 2019 (SG) 10201902307Y

(51) Int. Cl. G05D 19/02; F16F 15/00

(52) U.S. Cl. CPC G05D 19/02; F16F 15/002; F16F 15/007

(57) ABSTRACT

A vibration control system includes a plurality of spatially distributed transducer elements, a switching circuit, one or more vibration control circuits, and a controller circuit. The switching circuit is connected to each of the transducer elements. The one or more vibration control circuits are configured to perform vibration control, each of the one or more vibration control circuits being connected to the switching circuit. The controller circuit is configured to control the one or more vibration control circuits and the switching circuit. The switching circuit is configured to interconnect selected ones of the transducer elements based on a switching signal provided by the controller circuit, the switching signal being in response to a vibration condition, to adaptively form a group of interconnected transducer elements. The switching circuit is further configured to connect the group of interconnected transducer elements to a selected at least one of the one or more vibration control circuits for receiving a single vibration control signal or electrical impedance source corresponding to the vibration condition.

### FIELD OF INVENTION

The present invention relates broadly, but not exclusively, to a vibration control system, to a vibration control method and to a method of fabricating a vibration control system.

### BACKGROUND

Various techniques have been developed to control and attenuate noise and vibration in engineering systems, for example using passive materials, semi-active and active vibration control. One approach to control and attenuate noise and vibration makes use of electrically coupled piezoelectric materials applied on a host structure to form vibration control piezoelectric elements. This approach has not been integrated into commercial applications due to the technical challenges associated with dynamic and unpredictable vibration of macro-scale structures in practical situations.

However, when optimally designed, the approach of using electrically coupled piezoelectric materials for vibration control can be highly effective. Factors that may be considered during the design phase of this approach include the distribution of the piezoelectric materials that are applied on the host structure, the shapes of the piezoelectric materials and the locations that the piezoelectric materials are disposed of on the host structure. The effective distribution of the piezoelectric materials can be established via patterning the electrodes on the piezoelectric materials, or physically distributing the piezoelectric materials in the desired design topologies.

It has been proven in prior literature that, for a given vibration condition, there is one optimal effective distribution of the piezoelectric materials that maximizes the modal electromechanical coupling coefficient. Modal electromechanical coupling coefficient is also defined as the conversion efficiency between electrical and mechanical energy in a piezoelectric material at a particular resonance mode, which is widely accepted as an indicator of the effectiveness in noise and vibration control.

One of the conventional techniques used to control the vibrations on a host structure is to address the issue of the distribution of piezoelectric materials by optimizing the location, shape or number of piezoelectric patches. The disadvantage of this technique is that the final configuration of the piezoelectric material distribution is defined prior to manufacturing and thus may not be suitable for different vibration conditions during operation.

Another technique used to control the vibrations on a host structure includes optimizing the location and shape of electrodes covering the piezoelectric layer, instead of the piezoelectric materials. For example, a numerical topology optimization can be used to find the best pattern, or variable porosity distributed electrodes can be used. The disadvantage of this technique is that the electrode configuration is also static.

Further, controlling the vibrations on a host structure can be performed by designing shaped piezoelectric transducers or shaped electrodes with a spatial distribution based on the output response in different vibration modes, using numerical methods prior to manufacturing. However, the shapes of the piezoelectric transducers or electrodes are fixed during the design phase.

Another technique to control the vibrations on a host structure makes use of a multi-channel noise or vibration control system, including those used for the active noise cancellation. The multi-channel noise or vibration control system comprises multiple piezoelectric devices, each connected to a separate vibration controlling signal, thereby achieving noise or vibration reduction over a large spatial distribution. Due to the one-to-one coupling between the actuators and vibration controlling signals, an n-channel vibration control system with an n number of actuators would require an n number of signal channels for vibration control. Such a technique, therefore, cannot be effectively scaled up into a highly distributed system with vastly numerous actuators since an equivalent number of signal channels may not be realistically implementable.

A need therefore exists to provide a vibration control system that seeks to address at least some of the above problems.

### SUMMARY

An aspect of the present invention provides a vibration control system comprising:

a plurality of spatially distributed transducer elements;

a switching circuit connected to each of the transducer elements;

one or more vibration control circuits configured to perform vibration control, each of the one or more vibration control circuits being connected to the switching circuit; and

a controller circuit configured to control the one or more vibration control circuits and the switching circuit,

wherein the switching circuit is configured to interconnect selected ones of the transducer elements based on a switching signal provided by the controller circuit, the switching signal being in response to a vibration condition, to adaptively form a group of interconnected transducer elements; and

wherein the switching circuit is further configured to connect the group of interconnected transducer elements to a selected at least one of the one or more vibration control circuits for receiving a single vibration control signal or electrical impedance source corresponding to the vibration condition.

The vibration control system may further comprise a sensing circuit configured to detect the vibration condition, the sensing circuit being connected to the controller circuit.

The sensing circuit may be connected to the transducer elements for receiving outputs from the transducer elements as inputs.

The sensing circuit may comprise a Boolean switch configured to be controlled by the controller circuit to connect the sensing circuit to the transducer elements only during a sensing operation.

The sensing circuit may be connected to one or more vibration sensing elements disposed on a host structure.

The sensing circuit may be connected to a sensing layer disposed on a host structure and configured to detect the vibration condition.

The transducer elements may comprise discrete piezoelectric devices.

The transducer elements may comprise a piezoelectric layer and an electrode layer, and the electrode layer may comprise a plurality of electrode segments electrically isolated from each other.

The one or more vibration control circuits may be configured to perform vibration control based on dissipation, absorption or cancellation of vibration energy.

The one or more vibration control circuits may comprise a shunt circuit and/or an active control circuit.

At least a parameter of the one or more vibration control circuits may be configurable.

The system may be encapsulated in a unitary package, and the package may comprise a flexible material.

Another aspect of the present invention provides a vibration control method comprising:

spatially distributing a plurality of transducer elements;

interconnecting, by a switching circuit, selected ones of the transducer elements based on a switching signal provided by a controller circuit, the switching signal being in response to a vibration condition of a host structure, to adaptively form a group of interconnected transducer elements;

connecting, by the switching circuit, the group of interconnected transducer elements to at least one vibration control circuit; and

providing a single vibration control signal or electrical impedance source corresponding to the vibration condition to the group of interconnected transducer elements.

The vibration control method may further comprise determining the vibration condition of the host structure by a sensing circuit before interconnecting selected ones of the transducer elements.

The sensing circuit may be connected to the transducer elements, and inputs of the sensing circuit may comprise outputs from the transducer elements.

Determining the vibration condition of the host structure may further comprise controlling, by the controller circuit, a Boolean switch of the sensing circuit to connect the sensing circuit to the transducer elements only during a sensing operation.

The sensing circuit may be connected to one or more vibration sensing elements disposed on the host structure.

The sensing circuit may be connected to a sensing layer disposed on the host structure and configured to detect the vibration condition.

The transducer elements may comprise discrete piezoelectric devices.

The transducer elements may comprise a piezoelectric layer and an electrode layer, and the electrode layer may comprise a plurality of electrode segments electrically isolated from each other.

The vibration control method may further comprise dissipating, absorbing or cancelling vibration energy based on the single vibration control signal or electrical impedance source provided to the group of interconnected transducer elements.

The one or more vibration control circuits may comprise a shunt circuit and/or an active control circuit.

The vibration control method may further comprise configuring a parameter of the at least one vibration control circuit.

Another aspect of the present invention provides a method of fabricating a vibration control system, the method comprising:

providing a plurality of spatially distributed transducer elements;

connecting a switching circuit to each of the transducer elements;

connecting each of one or more vibration control circuits to the switching circuit;

connecting the one or more vibration control circuits and the switching circuit to a controller circuit,

programming the controller circuit to control the switching circuit to interconnect selected ones of the transducer elements based on a switching signal provided by the controller circuit, the switching signal being in response to a vibration condition, to adaptively form a group of interconnected transducer elements; and

programming the controller circuit to control the switching circuit to connect the group of interconnected transducer elements to a selected at least one of the one or more vibration control circuits for receiving a single vibration control signal or electrical impedance source corresponding to the vibration condition.

The method may further comprise connecting a sensing circuit to the controller circuit, and the sensing circuit may be configured to detect the vibration condition.

The method may further comprise connecting the sensing circuit to the transducer elements for receiving outputs from the transducer elements as inputs.

The method may further comprise connecting the sensing circuit to one or more vibration sensing elements disposed on a host structure.

The method may further comprise connecting the sensing circuit to a sensing layer disposed on a host structure and configured to detect the vibration condition.

The transducer elements may comprise discrete piezoelectric devices.

The transducer elements may comprise a piezoelectric layer and an electrode layer, and the method further may comprise electrically isolating a plurality of electrode segments of the electrode layer from each other.

The method may further comprise encapsulating the vibration control system in a unitary package, and the package may comprise a flexible material.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 is a schematic representation of a vibration control system, according to an example embodiment.

FIG. 2 is a schematic representation of a vibration control system with a sensing circuit, according to an example embodiment.

FIG. 3 is a schematic representation of a vibration control system with a sensing circuit, according to another example embodiment.

FIG. 4 is a top view of the piezoelectric elements, according to an example embodiment.

FIG. 5 is a top view of a piezoelectric layer, according to an example embodiment.

FIG. 6 is a schematic representation of a vibration control system encapsulated in a single package, according to example embodiment.

FIG. 7 shows an experimental setup for testing adaptive piezoelectric elements distribution.

FIG. 8 is a schematic representation of the electronic implementation of adaptive piezoelectric elements distribution of the experimental setup of FIG. 7.

FIG. 9, comprising FIGS. 9(a) and 9(b), shows example results of generated noise from individual electrode segments, using the experimental setup of FIG. 7.

FIG. 10, comprising FIGS. 10(a) and 10(b), shows example results of generated noise from multiple interconnected electrode segments, using the experimental setup of FIG. 7.

FIG. 11, comprising FIGS. 11(a) and 11(b), shows example results of active noise cancelling, using the experimental setup of FIG. 7.

FIG. 12 is a flowchart illustrating a vibration control method, according to an example embodiment.

FIG. 13 is a flowchart illustrating a method of fabricating a vibration control system, according to an example embodiment.

### DETAILED DESCRIPTION

Embodiments will be described, by way of example only, with reference to the drawings. Like reference numerals and characters in the drawings refer to like elements or equivalents.

In the present application, the term “adaptive” is defined as having the ability to change in time and space, for example in location, in shape and in amount, to suit different conditions, such as vibration conditions imposed by a host structure. The term “vibration condition” is defined as any physical variable inherent to the vibration nature of the host structure, such as the amplitude or phase of displacement, velocity, acceleration, voltage, current, as well as frequency or time lapse. Further, the term “piezoelectric” is defined as the ability of a material to convert mechanical energy into electrical energy, and vice versa. The term “host structure” refers to the supporting element for the transducer elements, which can be at the same time the source of mechanical vibrations from the perspective of the transducer elements. The host structure may include any mechanical structure prone to mechanical vibrations. For example, the material of the host structure can be aluminum, steel, glass, polymers, ceramics or composite materials. The host structure can also be a macro-scale structure, for example, those in the dimensions of millimeters, centimeters or meters. Additionally, the host structure can have shapes and surface topologies of varying complexities, such as in the form of a flat or curved panel, beam or tube. As non-limiting examples, the host structure can be a ship hull, an automotive chassis or a gearbox housing.

As described above, there is currently no known technique that controls noise and/or vibration on a host structure and which adaptively optimizes the distribution of piezoelectric materials or elements in response to various vibration conditions during operation. The currently known techniques use fixed piezoelectric distributions optimally designed for specific modes of vibration, and the piezoelectric distributions are not subject to any adaptive modification after the design or manufacturing phase.

The present disclosure addresses this technology gap by providing a vibration control system featuring multiple transducer elements in the form of piezoelectric elements. The piezoelectric elements may be configured to be selectively interconnected to achieve the optimal effective distribution of the piezoelectric materials in response to various vibration conditions. The piezoelectric elements can either be discrete piezoelectric devices, or a piezoelectric layer covered with a layer of segmented electrodes. The system may further include a switching circuit for interconnecting the piezoelectric elements, a controller circuit for commanding the switching circuit on the selection of the piezoelectric elements, and vibration control circuits configured to implement vibration control mechanisms which are capable of dissipating, absorbing, or even cancelling the vibration energy of the host structure, when coupled to the piezoelectric material. The controller circuit may also be configured to command the switching circuit to connect the effectively enlarged interconnected piezoelectric elements to the vibration control circuits. To improve the adaptation feature, the system can further include a sensing circuit for detecting the vibration conditions of the host structure, so that the controller circuit actively selects the piezoelectric elements for interconnection based on the real-time vibration conditions as detected. In this way, the effective distribution of the piezoelectric elements is optimized for the vibration conditions of the host structure at all times to realize highly effective noise and vibration control.

Notably, the present system and method are very different from the known multi-channel noise or vibration control technique as described above. In contrast to the known techniques, the present system and method can interconnect the piezoelectric elements via a switching circuit to realize the adaptation to different vibration conditions, and then couple the combined piezoelectric elements to a single vibration control signal. Such many-to-one coupling between the piezoelectric elements and the vibration control signals can enable much improved scalability for realizing highly effective noise and vibration control over a vast spatial distribution.

As described in further details below, the adaptation feature is enabled by a chain of events involving interconnecting the piezoelectric elements in response to different vibration conditions, and coupling the interconnected piezoelectric elements to the appropriate vibration control circuits. The adaptation can also be further enhanced by including an event for sensing the vibration conditions of the host structure, so that the interconnection of the piezoelectric elements can be performed based on the real-time vibration conditions as sensed. In an implementation, at a given time and for a given vibration condition of the host structure, the sensing circuit detects the vibration condition at one or multiple locations of the host structure. Thereafter, the controller circuit reads the output of the sensing circuit, selects the relevant piezoelectric elements for interconnection based on the information obtained from the sensing circuit, and sends the commands pertaining to the selection of the piezoelectric elements to the switching circuit. The switching circuit receives the commands from the controller circuit, provides an electrical interconnection between the selected piezoelectric elements, and couples the interconnected piezoelectric elements to one or more vibration control circuit. This process may be repeated in a loop for multiple time steps in order to adapt to multiple vibration conditions of the host structure over indefinite time steps. With an adaptive switching feature, the present system and method may achieve optimal effective distribution of the piezoelectric elements which, in turn, may result in an optimal modal electromechanical coupling coefficient, and therefore an optimal vibration control at all times. It will be appreciated that vibration may manifest as noise, thus controlling vibration can effectively result in controlling noise.

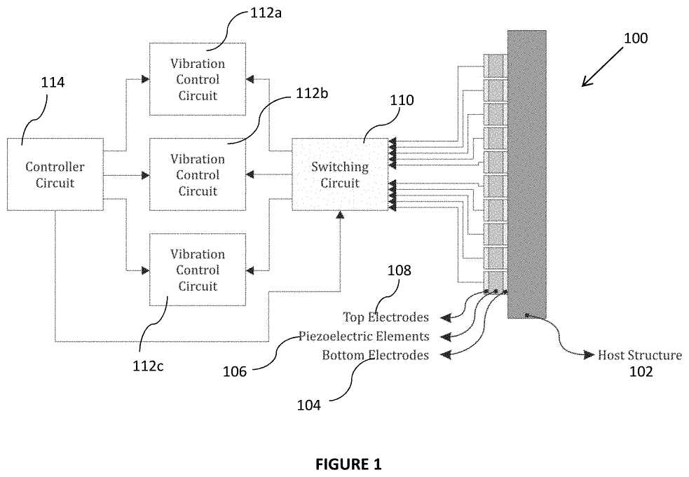

FIG. 1 is a schematic representation of a vibration control system 100, according to an example embodiment. The vibration control system 100 comprises a plurality of spatially distributed transducer elements 106, a switching circuit 110 connected to each of the transducer elements 106, one or more vibration control circuits 112a, 112b, 112c configured to perform vibration control, which each of the one or more vibration control circuits 112a, 112b, 112c are connected to the switching circuit 110, and a controller circuit 114 configured to control the one or more vibration control circuits 112a, 112b, 112c and the switching circuit 110. The switching circuit 110 is configured to interconnect selected ones of the transducer elements 106 based on a switching signal provided by the controller circuit 114, the switching signal being in response to a vibration condition, to adaptively form a group of interconnected transducer elements 106. The switching circuit 110 is further configured to connect the group of interconnected transducer elements 106 to a selected at least one of the one or more vibration control circuits 112a, 112b, 112c for receiving a single vibration control signal or electrical impedance source corresponding to the vibration condition.

The plurality of spatially distributed transducer elements 106 may be in the form of distributive piezoelectric elements 106 disposed on a host structure 102, whereby the piezoelectric elements 106 can be selectively electrically interconnected in order to adapt the effective distribution of the piezoelectric materials to the current vibration condition of the host structure 102. The controller circuit 114 may be configured to command the switching circuit 110 on the selection of the piezoelectric elements 106. The vibration control circuits 112a, 112b, 112c may be configured to implement vibration control mechanisms when coupled to the piezoelectric elements 106.

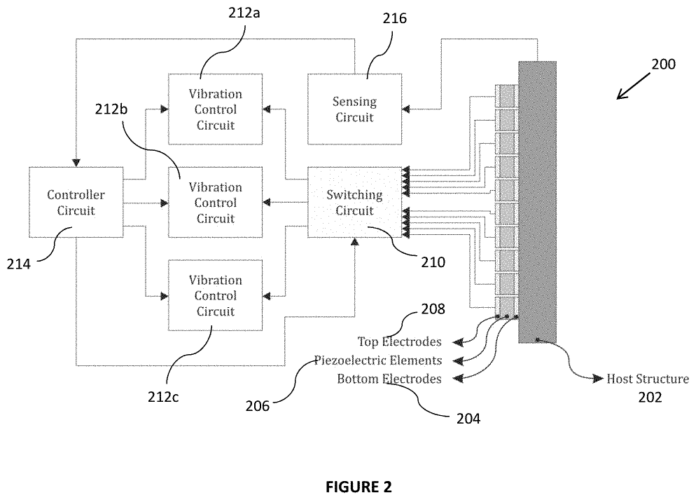

Additionally, the vibration control system in the present disclosure may include at least one sensing circuit configured to detect the noise or vibration condition at any location of the host structure. FIG. 2 is a schematic representation of a vibration control system 200 with a sensing circuit 216, according to another example embodiment. The sensing circuit 216 is configured to detect the vibration condition in real-time. Further, the sensing circuit 216 is connected to the controller circuit 214. The sensed vibration information from the sensing circuit 216 may be output to the controller circuit 214 for facilitating the selection of the piezoelectric elements 206 in response to the vibration conditions. It will be appreciated that the sensing circuit 216 may comprise electrical and/or electronic components, such as amplifiers, filters, digital signal processors, microcontroller or other programmable or non-programmable electronic devices.

In one implementation, the sensing circuit 216 is connected to the transducer elements 206 for receiving outputs from the transducer elements 206 as inputs. In other words, the sensing circuit 216 may contain one or more inputs which are electrically connected to each or any one of the piezoelectric elements 206, and the inputs are configured to read the electrical outputs generated at each of the piezoelectric elements 206, so as to detect the vibration conditions at any location of the host structure 202 as covered by the piezoelectric elements 206. In this configuration, the piezoelectric elements 206 serve as the vibration sensing elements.

In the above implementation, the sensing circuit 216 may further comprise a Boolean switch (not shown) configured to be controlled by the controller circuit 214 to connect the sensing circuit 216 to the transducer elements 206 only during a sensing operation. The Boolean switch may be configured to connect or disconnect electrical connections to the piezoelectric elements 206. The Boolean switch may be implemented on, for example, a relay, a transistor (e.g. a MOSFET), or a logic device. For example, the Boolean switch may be configured to connect the sensing circuit 216 to the piezoelectric elements 206 only during the sensing operation, and disconnect the sensing circuit 216 from the piezoelectric elements 206 when the sensing operation is completed or not required. Further, the Boolean switch may also be controlled by the controller circuit 214, which coordinates the chain of events in the system.

In another implementation, the sensing circuit 216 is connected to one or more vibration sensing elements (not shown) disposed on a host structure. The one or more inputs to the sensing circuit are coupled to one or more noise or vibration sensing elements distributed in a periodic or aperiodic repetition on the host structure. The coupling between the sensing circuit and the noise or vibration sensing elements can be direct or indirect electrical connection, or via wireless connection. The noise or vibration sensing elements may include microphones, accelerometers, piezoelectric devices, piezo-resistive or piezo-capacitive devices, seismic sensor, or tilt switch sensors.

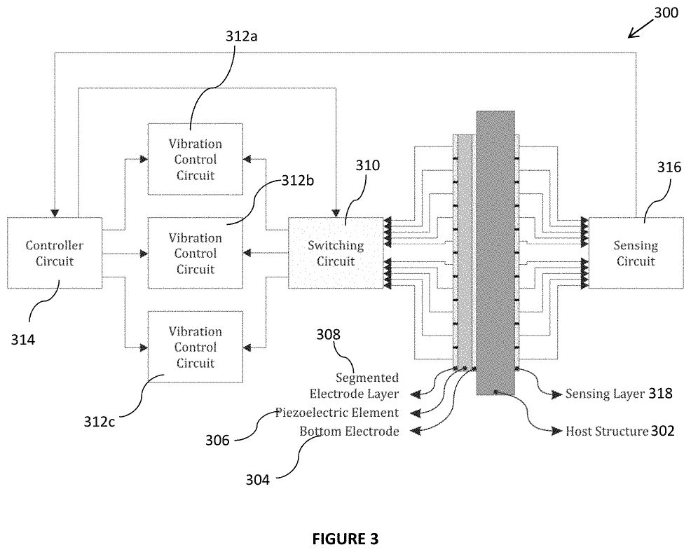

In another implementation, the inputs to the sensing circuit are coupled to a sensing layer disposed on the host structure, whereby the sensing layer is configured to detect the vibration condition of the host structure. FIG. 3 is a schematic representation of vibration control system 300 with a sensing layer 318, according to another example embodiment. The sensing circuit 316 is connected to the sensing layer 318 disposed on a host structure 302 and configured to detect the vibration condition. The sensing circuit 316 may receive inputs from the sensing layer 318 disposed on the host structure 302, whereby the sensing layer 318 is configured to detect the vibration condition of the host structure 302 and provide the information to the controller circuit 314.

The sensing layer 318 may be disposed on a surface of the host structure 302 and is configured to detect the vibration condition of the host structure 302. As example only, the sensing layer 318 may be located on top of the piezoelectric elements or on the opposite surface of the host structure 302 and may have sensing locations preferably similarly segmented as the piezoelectric elements. In this way, the sensing layer can provide an output indicative of the vibration condition at each of its segments.

The sensing layer 318 may comprise one or more discrete vibration sensing elements, such as accelerometers, piezoelectric devices, piezo-resistive or piezo-capacitive devices, seismic sensor, or tilt switch sensors attached onto a surface of the host structure 302. Alternatively, the sensing layer 318 may comprise one or more piezoelectric layers established on a surface of the host structure 302 by means of adhesive bonding or deposition techniques. In this case, the piezoelectric layers may be based on a piezoelectric polymer, a piezoelectric composite (which is comprised of piezoelectric particles dispersed within a polymeric medium), or a piezoelectric ceramic.

As shown in FIG. 3, the transducer elements may comprise a bottom electrode layer 304, a piezoelectric layer 306 and a top electrode layer 308. The top electrode layer 308 comprises a plurality of electrode segments each having a respective connection to the switching circuit 310 which is coupled to the vibration control circuits 312a, 312b, 312c.

During operation, the sensing circuit 216, 316 can provide output containing information on vibration conditions as obtained from the piezoelectric elements, the vibration sensing elements, or the sensing layer. The vibration information can be, for example, a voltage, displacement, velocity, frequency or acceleration. The output may be coupled to an input of the controller circuit 214, 314 so that the information on the vibration conditions can be used for event coordination by the controller circuit 214, 314.

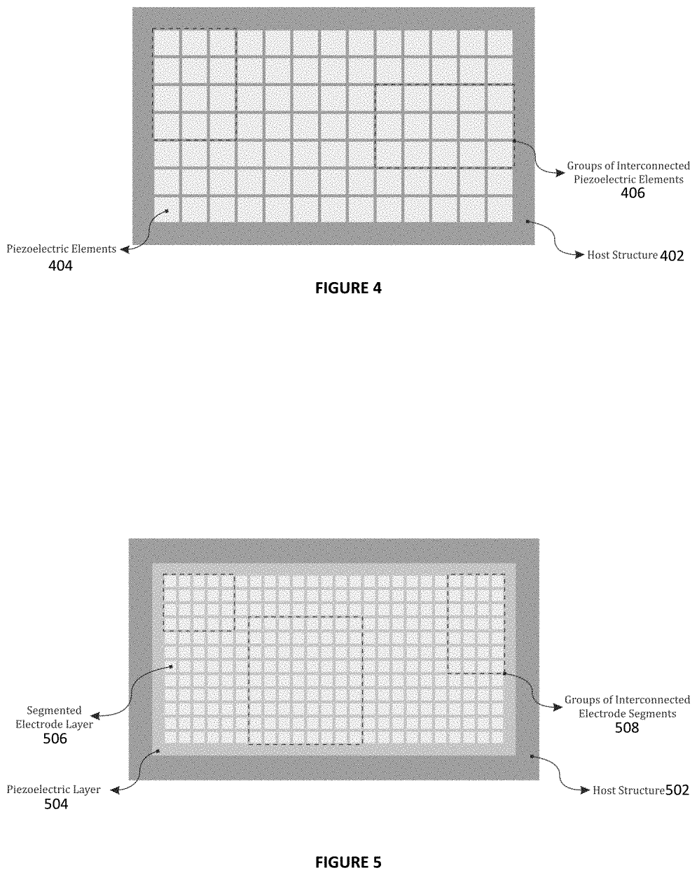

With reference to FIGS. 1-3, some examples of the transducer elements are now described. As an example, the transducer elements comprise discrete piezoelectric devices. The discrete piezoelectric devices may be piezoelectric plates, patches or discs, attached onto the host structure. FIG. 4 is a top view of distributive piezoelectric elements 404, such as ones used in FIGS. 1 and 2 according to an example embodiment. There may be multiple transducer elements in the form of piezoelectric elements 404 distributed on the host structure 402. The transducer elements 404 can be interconnected via the switching circuit as described above with reference to FIGS. 1-3 to form groups 406 of transducer elements. The groups 406 of transducer elements can be groups of interconnected piezoelectric elements 306.

The piezoelectric elements 404 may be configured so that they are not limited to any surface topologies, shapes, thicknesses and distribution on the host structure. The piezoelectric elements 404 may fully cover or partially cover the surface of the host structure, and may or may not conform to the surface topologies of the host structure. Alternatively, the piezoelectric elements 404 may also be segmented to form periodic or aperiodic array of points or patches distributed on the host structure. The piezoelectric elements 404 may adopt varying thicknesses, including those in the dimensions of nanometers, micrometers or millimeters.

The piezoelectric materials used for the piezoelectric elements 404 can be based on ferroelectric ceramic or oxides materials, for example, lead zirconate titanate (PZT). Alternatively, the piezoelectric materials may be based on ferroelectric polymer materials, or piezoelectric composite materials comprising piezoelectric particles dispersed within a polymeric medium.

As another example, the transducer elements comprise a piezoelectric layer with an electrode layer, whereby the electrode layer comprised of multiple electrode segments. In this way, each location of the piezoelectric layer as covered by the electrode segment behaves as a single piezoelectric element, and the effective distribution of the piezoelectric elements can be configured by interconnecting the electrode segments via the switching circuit, and couple to the vibration control circuits. At least one electrode layer may be disposed onto the piezoelectric elements, so that an external circuit can be connected and vibration control can be performed.

FIG. 5 is a top view of a piezoelectric layer 504 with a layer of top electrode segments 508, according to an example embodiment. The transducer elements here are in the form of a piezoelectric layer 504 with a segmented electrode layer 506. There may be only one electrode layer on top of the piezoelectric layer 504 to form the top electrode. The host structure 502 can be electrically conductive thus enabling electrical contact with the bottom side of the piezoelectric layer 504. The top electrode may fully cover or partially cover the piezoelectric layer 504. The top electrode may be segmented in the planar direction, or the electrode segments 508 may be disposed in-plane on the surface of the piezoelectric layer 504. Each electrode segment 508 may be electrically isolated from its neighbouring segments by a physical gap. The electrode segments 508, as well as the gaps between the electrode segments 508, need not be confined to any shapes or sizes. As non-limiting examples, the shapes of the electrode segments 508, as well as the gaps between the electrode segments 508, may include lines, squares, rectangles, triangles, circles or any other regular or irregular shapes. Also, the electrode segments 508, as well as the gaps between the electrode segments 508, may be in dimensions of micrometer, millimeters, centimeters or meters. The electrode segments 508, or the gaps between the electrode segments 508, may also be disposed on the top surface of the piezoelectric layer 504 in a periodic or aperiodic repetition, for example in a rectangular array, a variable triangular mesh or a honeycomb. The electrode segments 508 can be interconnected into groups via the switching circuit as described above with reference to FIGS. 1-3.

In another embodiment, such as one used in FIG. 3, in addition to the top electrode, a bottom electrode may be disposed on the other side of the piezoelectric layer opposite to the top electrode. The host structure may or may not be electrically conductive. The bottom electrode may fully or partially cover the piezoelectric layer, may cover the same area as the top electrode, and may or may not be segmented.

As non-limiting examples, the top and/or bottom electrodes can be of electrically conductive materials, including metallic materials, carbon materials, conductive metal oxides, conductive metal-metal oxide composites or electrically conductive polymers. Further, the top and/or bottom electrodes can be formed by deposition techniques such as sputtering, evaporation, spray-coating, dip-coating, solution-casting or spin-coating, with or without a shadow mask.

As described above with reference to FIGS. 1-3, there may be at least one switching circuit configured for electrically interconnecting, grouping, or short-circuiting, multiple transducer elements to form at least one, or a plurality of, effectively enlarged transducer element groups. The switching circuit allows an optimized effective distribution of the piezoelectric materials for vibration conditions of the host structure at a given time.

In an implementation, the switching circuit may comprise one or more electrical connections to interconnect the transducer elements such that the interconnected transducer elements are effectively larger in size, and fewer in number, than the original transducer elements. In this implementation, the effective distributions of the transducer elements can be altered to present any shapes, for example rectangles, triangles, circles, or any other regular or irregular shapes. Further, the switching circuit may receive a command from the controller circuit on the transducer elements that have to be interconnected.

The switching circuit may contain, for example, electrical and/or electronic components, such as relays, multiplexers or digital signal processors, logic devices, network switches, programmable logic devices, microcontrollers and other programmable or non-programmable electronics devices.

As shown in FIGS. 1-3, the switching circuit may have electrical connections to couple each interconnected transducer elements group to at least one vibration control circuit. The switching circuit may receive a command from the controller circuit on the selection of the vibration control circuits to be coupled to an interconnected transducer elements group. There may not be any limitation on the combination of the coupling between the interconnected transducer elements groups and the vibration control circuits. As a non-limiting example, the switching circuit may couple one interconnected transducer elements group to one vibration control circuit, or multiple interconnected transducer elements groups to one vibration control circuit. In another example, the switching circuit may couple one interconnected transducer elements group to multiple vibration control circuits, or multiple interconnected transducer elements groups to multiple vibration control circuits. In all of these coupling combinations, the individual transducer elements within an interconnected group are all coupled to the same vibration control signal, or the same electrical impedance source.

With reference to FIGS. 1-3, there may be at least one vibration control circuit. The vibration control circuit is configured to execute noise or vibration control mechanism on the host structure when coupled to the transducer elements. The vibration control mechanism may be based on the electro-mechanical energy conversion ability of piezoelectric elements. In one implementation, the one or more vibration control circuits are configured to perform vibration control based on dissipation, absorption or cancellation of vibration energy. The vibration control circuit, or plurality of these vibration control circuits, may be selectively and electrically connected to the interconnected transducer elements groups via the switching circuit, as commanded by the controller circuit.

The vibration control circuit may be configured to dissipate the electrical charge generated by the piezoelectric elements, so as to dissipate the vibration energy. The vibration control circuit can also be configured to influence the effective mechanical properties of the piezoelectric elements on the host structure, for example the mechanical impedance, compliance, damping, effective mass or the Young's modulus to realize the desired vibration or noise control effects. Alternatively, the vibration control circuit may be configured to actively generate mechanical actuation on the piezoelectric elements. In this implementation, in order to control the noise or vibration, the piezoelectric actuation can be configured to be anti-phase to the vibration of the host structure, anti-phase to the acoustic noise generated by the host structure, or anti-phase to the excitation source of the vibration.

The vibration control circuit may also be configured to include known control mechanisms, such as amplification, attenuation, damping, eigenfrequency shift as well as adaptive filters.

In an embodiment, the one or more vibration control circuits comprise a shunt circuit and/or an active control circuit. The vibration control circuit may be a passive shunt circuit connected across the piezoelectric elements. For example, the shunt circuit for vibration control may comprise passive electrical components, such as a resistor, an inductor, a capacitor, or the combination of any of these components. The shunt circuit may be configured to match against an electrical parameter of the piezoelectric elements, such as the electrical impedance, dielectric capacitance or series resistance, for optimal vibration or noise control effects.

In another embodiment, the vibration control circuit may be a semi-passive or semi-active shunt circuit connected across the transducer elements. For example, the semi-passive or semi-active shunt circuit can be a negative impedance converter circuit, a negative capacitance converter, a negative resistance converter, or a synthetic inductor based on, for example, an operational amplifier. The semi-passive or semi-active shunt circuit may be configured to match against an electrical parameter, such as the electrical impedance, dielectric capacitance or series resistance, of the transducer elements.

In yet another embodiment, the vibration control circuit may be an active control circuit configured to provide an electrical control signal to actuate the transducer elements. The active control circuit can be configured to actuate the transducer elements in an anti-phase manner to the vibration of the host structure, anti-phase to the acoustic noise generated by the host structure, or anti-phase to the excitation source of the structural vibration. In this implementation, the active control circuit can be connected to a feedback sensor that detects the vibration of the host structure. The vibration information as detected by the sensor can be fed back to the active control circuit for adjusting the actuation amplitude and phase of the control signal in order to optimally attenuate the vibration of the host structure.

Further, at least a parameter of the one or more vibration control circuits is configurable in real-time. The vibration control circuit is adaptive to the real-time vibration of the host structure, and enables one or more of its parameters to be further modified or configured by an input command during operation. The command for configuring the parameters of the vibration control circuit may be an output from the controller circuit, which can be configured to achieve an optimal value of the parameter of vibration control circuit based on the vibration information obtained from the sensing circuit, or based on the known parameters of the transducer elements at certain vibration conditions. For example, the parameters of the vibration control circuit to be configured may comprise any of the electronic component's values in the vibration control circuit, such as the value of a resistor, or a capacitor or an inductor. The parameters of the vibration circuit to be configured may also refer to the electrical characteristics of the circuit, including the circuit's impedance, frequencies, amplitude, phase-shift.

With reference to FIGS. 1-3, there is one controller circuit that coordinates and triggers the chain of events, including those occurring at the sensing circuit, the switching circuit and the vibration control circuit. In one implementation, the controller circuit receives an input from the sensing circuit on the information of the vibration condition of the host structure. In this implementation, the controller circuit may be coupled to the sensing circuit to receive the information output by the sensing circuit. The coupling may be via physical electrical wiring between the two circuits, or via wireless data transmission, for example radio-frequency (RF) or infra-red (IR). The vibration information may include vibration amplitude, velocity, acceleration or frequency of the host structure, and may further include information on other environmental conditions, such as the ambient temperature.

As described above, the controller circuit may include an additional Boolean output connected to the sensing circuit, to coordinate the connection of the sensing circuit to the piezoelectric elements. The sensing circuit may include a switch configured to be commanded by the Boolean output of the controller circuit. Using the Boolean output, the controller circuit can command the switching circuit to connect the sensing circuit to the piezoelectric elements only during sensing operation, and disconnect the sensing circuit from the piezoelectric elements when the sensing operation is completed or not required.

The controller circuit may be configured to process the information received from the sensing circuit to determine the optimal spatial distribution of the electrode on the piezoelectric elements under a vibration condition. The controller circuit may include an algorithm configured to relate the transducer elements' distribution to certain vibration conditions, to determine the optimal transducer elements' distribution for the desired vibration control, and to translate the optimal transducer elements' distribution into the selection of transducer elements for interconnection.

Further, the controller circuit may provide an output to the switching circuit for the selection of the transducer elements for interconnection. The controller circuit can command the switching circuit to interconnect the transducer elements as determined by the controller circuit for optimal vibration control. The coupling between the controller circuit and switching circuit may be via physical electrical connections or via wireless data transmission such as radio-frequency (RF) or infra-red (IR).

The controller circuit may also provide an output to the switching circuit for commanding the coupling of the interconnected transducer elements groups to the vibration control circuit. The interconnected transducer elements groups can be coupled to the relevant vibration control circuits for optimizing the vibration or noise control performance.

The controller circuit may also provide an output to each of the vibration control circuits with the output commanding the vibration control circuits to modify or configure one or more of its parameters for real-time adaptation to different vibration conditions and/or transducer elements' distribution. The parameters of the vibration control circuit may include values of any electrical or electronic components in the circuit, or the electrical characteristics of the circuit such as the impedance, frequencies, amplitude and phase-shift. The controller circuit may include an algorithm relating the parameters of the vibration control circuit to the vibration condition and/or transducer elements' distribution, determine the optimal parameters for the desired vibration control and outputting the optimal parameter into an output command executable by the vibration control circuit. The coupling between the controller circuit and vibration control circuit may be via physical electrical wiring between the two circuits, or via wireless data transmission including those of radio-frequency (RF) or infra-red (IR).

The controller circuit may comprise electrical and/or electronic components or systems, including digital signal processors, programmable devices, microcontrollers, digital logic devices and analogue devices, configured to coordinate and trigger the chain of events of the vibration control system.

With reference to FIGS. 1-3, in one embodiment, the individual components (the transducer elements, the sensing circuit, the switching circuit, the vibration control circuit and the controller circuit), which enable the adaptive piezoelectric vibration control, may be constructed, manufactured or operated as separate physically entities, with each entity connected by electrical wiring or wireless transmission

In another embodiment, some or all of the aforementioned individual components may be encapsulated or embedded within one single package that has all the necessary elements to perform an adaptive piezoelectric vibration control. The single package can be physically flexible to enable easy attachment onto the host structures of varying profile complexities.

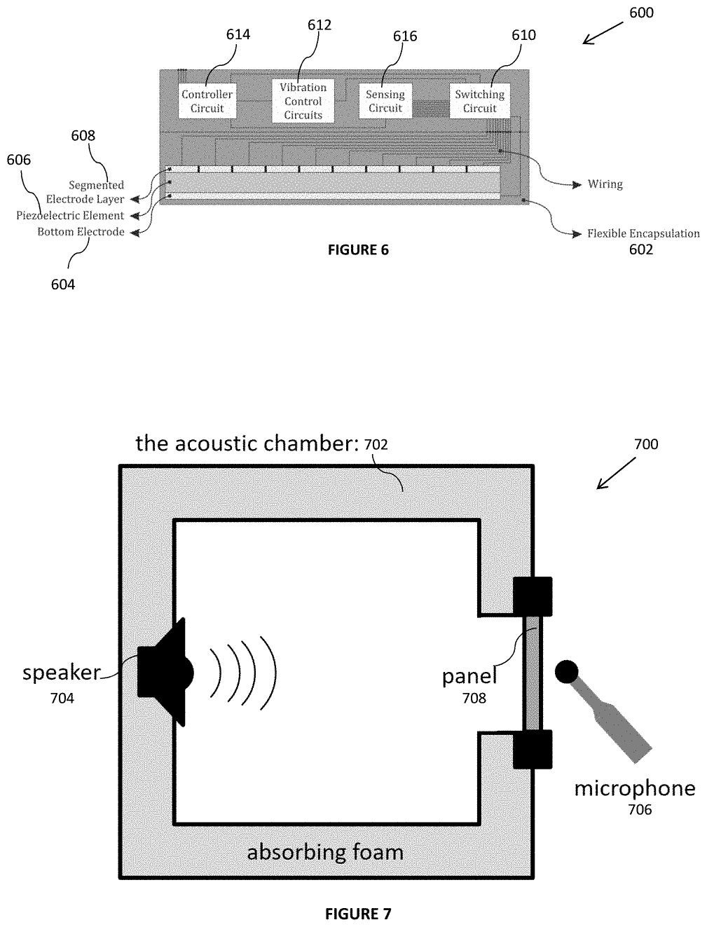

FIG. 6 is a schematic representation of a vibration control system 600 encapsulated in a single package, according to another example embodiment. The system 600 is encapsulated in a unitary package, and the package comprises a flexible material. The transducer elements 606 are in the form of a piezoelectric layer with a non-segmented bottom electrode 604 and a segmented top electrode 608, and are surrounded by the package material. Alternatively, the transducer elements in the package may exist as discrete piezoelectric devices each comprising its own piezoelectric material and electrodes, instead of a piezoelectric layer.

On the top of the package, the electrical connections to the bottom electrode 604 and to the segments of the top electrode 608 protrude. Also on the top of the package, the sensing circuit 616, the switching circuit 610, the vibration control circuit 612 and the controller circuit 614 are disposed together with the wiring that connects the circuits and the electrical connections of the electrodes. These components are further encapsulated by the same package material. The electrical connections for power supply and data transfer may protrude at the top of the package. The bottom part of the package can be disposed onto the host structure, for example, by adhesive bonding.

In an implementation, a sensing layer may be present in the package. The sensing layer may be located on top of the transducer elements or on the bottom electrode of the transducer elements, and may have sensing locations similarly segmented as the transducer elements.

In another implementation, a power supply circuit may be present in the package. On top of the package, electrical connections may not protrude and the package for adaptive piezoelectric vibration control can be completely functional autonomously.

The package may be based on a flexible thermoplastic polymer matrix material which is electrically isolating, such as polyamide or polyetheretherketone (PEEK).

Experimental analyses have been carried out to determine the benefits of having the adaptive piezoelectric elements' distribution that finds the best distribution of the electrodes of a piezoelectric layer in response to various vibration conditions.

FIG. 7 shows an experimental setup 700 for testing adaptive piezoelectric elements distribution. The experimental setup comprises an acoustic chamber 702 with a speaker 704 inside as the noise source and a microphone 706 outside to measure the noise level. A piezoelectric panel 708 comprising a piezoelectric layer with 16 individual top electrode segments and a common bottom electrode is attached to the window of the chamber 702. The piezoelectric panel 708 is used to perform active noise cancellation to reduce the noise level from the source. The cancelling effect is captured by the microphone 706 connected to a data acquisition system (DAQ).

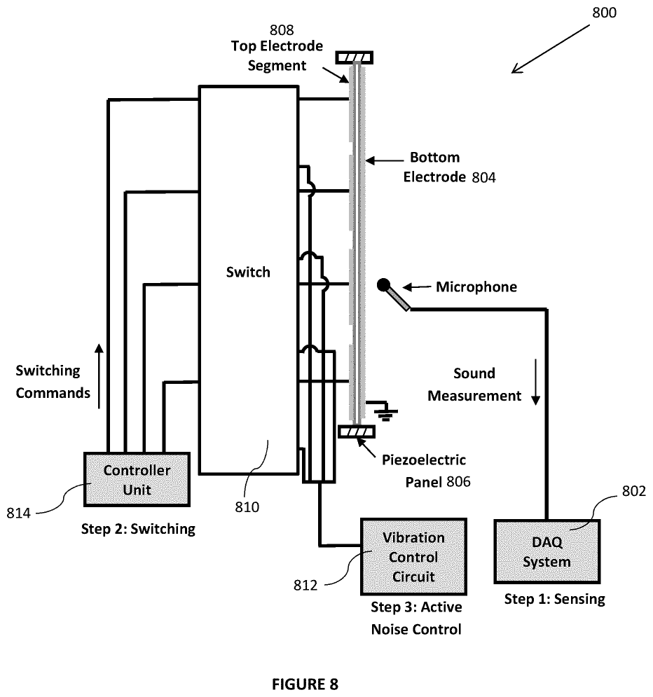

FIG. 8 is a schematic representation 800 of the electronic implementation of adaptive piezoelectric elements distribution of the experimental setup of FIG. 7. As illustrated in the simplified schematics of the electronic implementation of the adaptive electrode system, each individual electrode segment 808 is coupled to a switch 810, which collectively constitutes the switching circuit according to example embodiments. The switching is controlled by a programmable controller 814, such that any of the electrode segments 808 can be combined together and coupled to a vibration control circuit 812 configured for active noise cancellation.

In this proof of concept demonstration, the electrode adaptation involves combining the electrode segments one by one, starting from the one with highest sound level output. The noise levels of the individual electrode segments at the targeted frequencies are pre-measured so as to facilitate the ranking of the electrode segments based on the sound amplitude. The electrodes combination which produces the maximum sound amplitude at the targeted frequencies would then be utilized for achieving the optimum active noise cancellation effects.

The proof of concept demonstration is described in detail below.

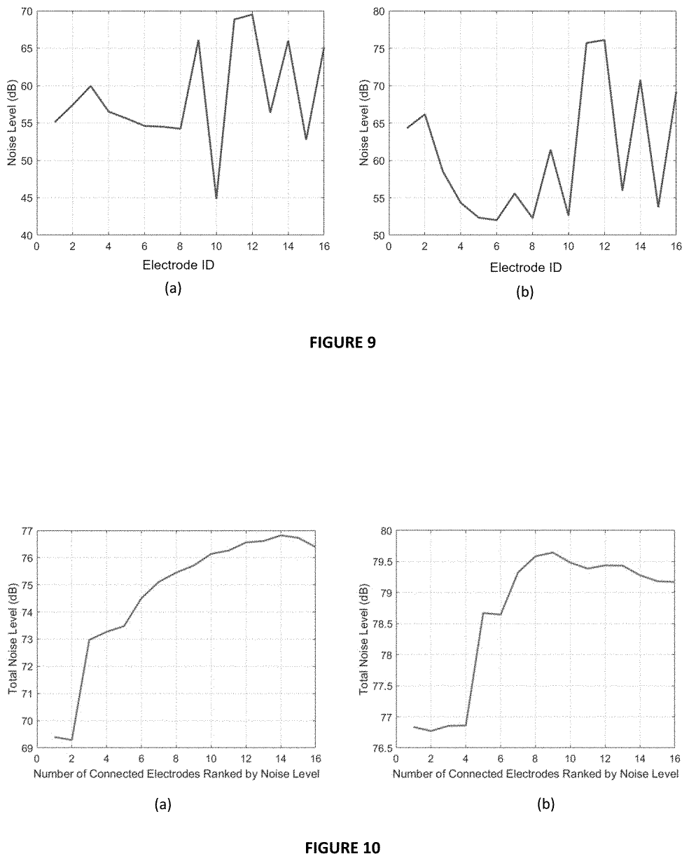

The first step of the proof of concept demonstration is sensing. Initially, each of the 16 electrode segments of the piezoelectric panel is individually driven with a sinusoidal voltage at 2 different vibration conditions, one at 286 Hz and another at 325 Hz. The output sound level is measured by the microphone for each segment. FIG. 9, comprising FIGS. 9(a) and 9(b), shows example results of generated noise from individual electrode segment at 286 Hz and 325 Hz respectively, using the experimental setup of FIG. 7. This shows which of the segments generate the highest sound levels that will be used later for active noise cancellation.

Second step of the proof of concept demonstration is switching. The second step involves interconnecting the electrode segments and finding the best combination that will result in the best noise cancelling effect. This is done by interconnecting the segments ranked by the highest individual sound level to the lowest, one by one, until all the segments are interconnected. For each of the 16 possible interconnections, they are driven with a sinusoidal voltage and the total sound level generated by the panel is measured by the microphone. FIG. 10, comprising FIGS. 10(a) and 10(b), shows example results of generated noise from multiple interconnected electrode segments at 286 Hz and 325 Hz respectively, using the experimental setup of FIG. 7. It can be seen that there is only one possible combination that will lead to a maximum total sound level generated by the panel. In the case of 286 Hz, that corresponds to 14 interconnected segments, and in the case of 325 Hz, that corresponds to 9 interconnected segments.

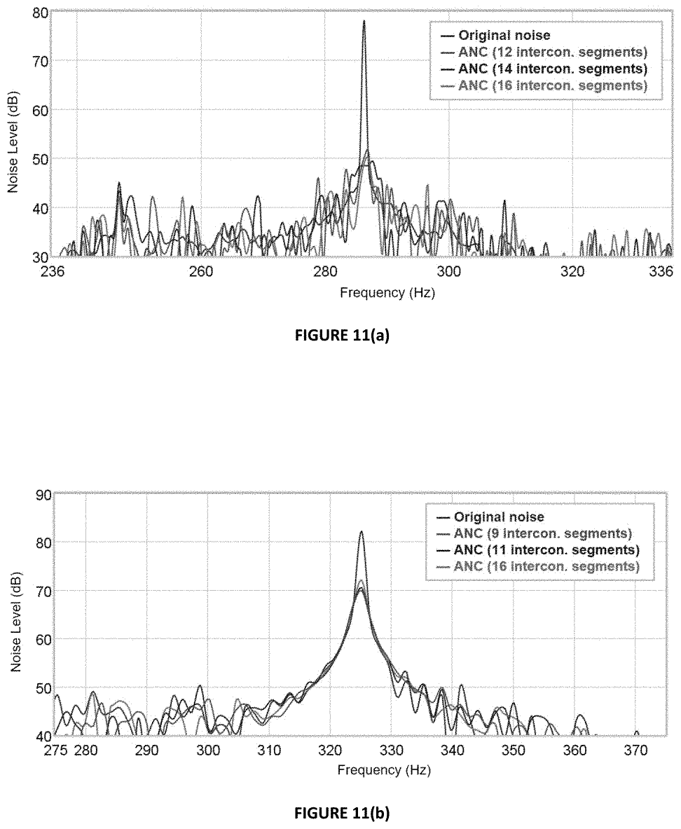

Third step of the proof of concept demonstration is active noise control. FIG. 11, comprising FIGS. 11(a) and 11(b), shows example results of active noise cancelling, using the experimental setup of FIG. 7. As shown in FIG. 11, if the noise source is activated at 286 Hz without any active noise control, the measured noise level is 78 dB, while at 325 Hz, the measured noise level is 82 dB. If all the 16 segments of the piezoelectric panel are interconnected to perform active noise control, without the adaptation feature, it can be seen that this configuration does not represent the maximum noise cancelling effect possible. In this case, the cancelling effect can reduce the noise by 28 dB and 10 dB at 286 Hz and 325 Hz, respectively. However, if the adaptation feature is used and the segments are interconnected in an optimal way (14 segments at 286 Hz and 9 segments at 325 Hz), it can be seen that there is a further 2 dB noise cancelling for both cases. This demonstrates the benefit of having adaptive electrodes under different vibration conditions.

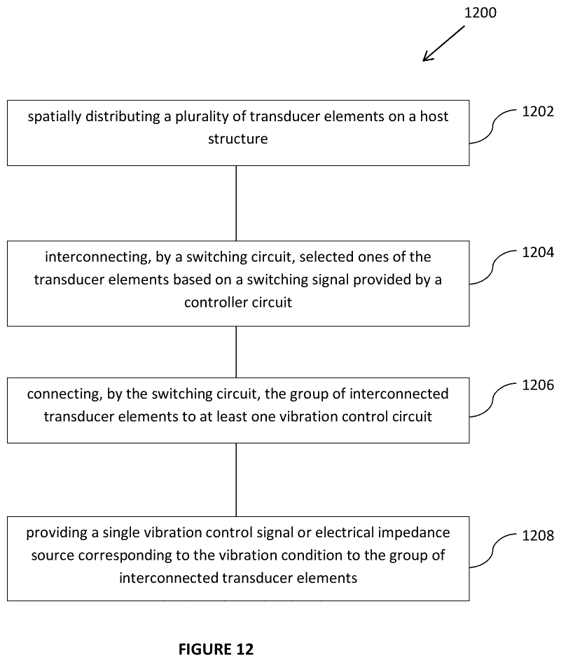

FIG. 12 is a flowchart 1200 illustrating a vibration control method, according to an example embodiment. At step 1202, a plurality of transducer elements are spatially distributed. At step 1204, selected ones of the transducer elements are interconnected by a switching circuit based on a switching signal provided by a controller circuit, the switching signal being in response to a vibration condition of a host structure, to adaptively form a group of interconnected transducer elements. At step 1206, the group of interconnected transducer elements are connected, by the switching circuit, to at least one vibration control circuit. At step 1208, a single vibration control signal or electrical impedance source corresponding to the vibration condition is provided to the group of interconnected transducer elements.

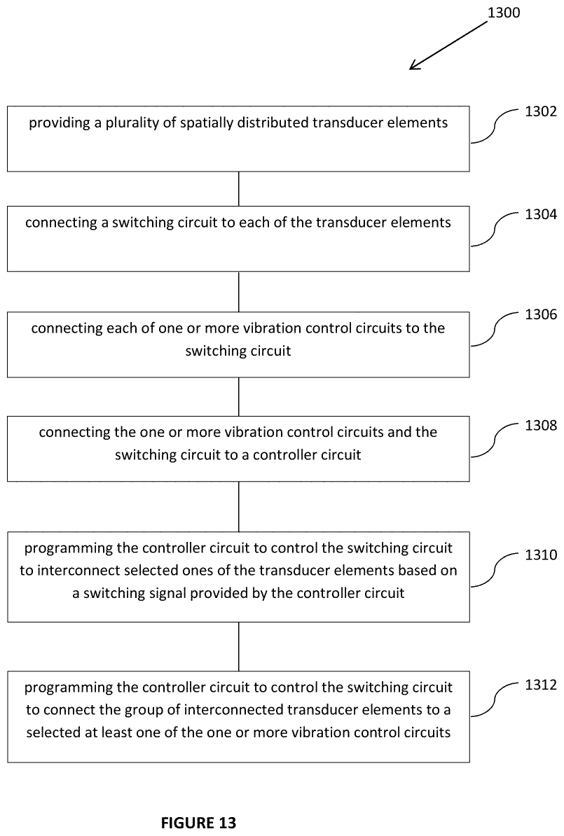

FIG. 13 is a flowchart 1300 illustrating a method of fabricating a noise and vibration control system, according to an example embodiment. At step 1302, a plurality of spatially distributed transducer elements are provided. At step 1304, a switching circuit is connected to each of the transducer elements. At step 1306, each of one or more vibration control circuits is connected to the switching circuit. At step 1308, the one or more vibration control circuits and the switching circuit is connected to a controller circuit. At step 1310, the controller circuit is programmed to control the switching circuit to interconnect selected ones of the transducer elements based on a switching signal provided by the controller circuit, the switching signal being in response to a vibration condition, to adaptively form a group of interconnected transducer elements. At step 1312, the controller circuit is programmed to control the switching circuit to connect the group of interconnected transducer elements to a selected at least one of the one or more vibration control circuits for receiving a single vibration control signal or electrical impedance source corresponding to the vibration condition.

It will be appreciated by a person skilled in the art that numerous variations and/or modifications may be made to the present invention as shown in the specific embodiments without departing from the scope of the invention as broadly described. The present embodiments are, therefore, to be considered in all respects to be illustrative and not restrictive.

1. A vibration control system comprising:
a plurality of spatially distributed transducer elements;
a switching circuit connected to each of the transducer elements;
one or more vibration control circuits configured to perform vibration control, each of the one or more vibration control circuits being connected to the switching circuit; and
a controller circuit configured to control the one or more vibration control circuits and the switching circuit,
wherein the switching circuit is configured to interconnect selected ones of the transducer elements based on a switching signal provided by the controller circuit, the switching signal being in response to a vibration condition, to adaptively form a group of interconnected transducer elements; and
wherein the switching circuit is further configured to connect the group of interconnected transducer elements to a selected at least one of the one or more vibration control circuits for receiving a single vibration control signal or electrical impedance source corresponding to the vibration condition.

2. The vibration control system according to claim 1, further comprising a sensing circuit configured to detect the vibration condition, the sensing circuit being connected to the controller circuit.

3. The vibration control system according to claim 2, wherein the sensing circuit is connected to the transducer elements for receiving outputs from the transducer elements as inputs, and wherein the sensing circuit comprises a Boolean switch configured to be controlled by the controller circuit to connect the sensing circuit to the transducer elements only during a sensing operation.

4. (canceled)

5. The vibration control system according to claim 2, wherein the sensing circuit is connected to one or more vibration sensing elements disposed on a host structure.

6. The vibration control system according to claim 2, wherein the sensing circuit is connected to a sensing layer disposed on a host structure and configured to detect the vibration condition.

7. The vibration control system according to claim 1, wherein the transducer elements comprise discrete piezoelectric devices.

8. The vibration control system according to claim 1, wherein the transducer elements comprise a piezoelectric layer and an electrode layer, and wherein the electrode layer comprises a plurality of electrode segments electrically isolated from each other.

9. The vibration control system according to claim 1, wherein the one or more vibration control circuits are configured to perform vibration control based on dissipation, absorption, or cancellation of vibration energy.

10. (canceled)

11. The vibration control system according to claim 1, wherein at least a parameter of the one or more vibration control circuits is configurable.

12. The vibration control system according to claim 1, wherein the system is encapsulated in a unitary package, and wherein the package comprises a flexible material.

13. A vibration control method comprising:
spatially distributing a plurality of transducer elements;
interconnecting, by a switching circuit, selected ones of the transducer elements based on a switching signal provided by a controller circuit, the switching signal being in response to a vibration condition of a host structure, to adaptively form a group of interconnected transducer elements;
connecting, by the switching circuit, the group of interconnected transducer elements to at least one vibration control circuit; and
providing a single vibration control signal or electrical impedance source corresponding to the vibration condition to the group of interconnected transducer elements.

14. The vibration control method according to claim 13, further comprising determining the vibration condition of the host structure by a sensing circuit before interconnecting selected ones of the transducer elements.

15. The vibration control method according to claim 14, wherein the sensing circuit is connected to the transducer elements, and wherein inputs of the sensing circuit comprise outputs from the transducer elements; and wherein determining the vibration condition of the host structure further comprises controlling, by the controller circuit, a Boolean switch of the sensing circuit to connect the sensing circuit to the transducer elements only during a sensing operation.

16. (canceled)

17. The vibration control method according to claim 14, wherein the sensing circuit is connected to one or more vibration sensing elements disposed on the host structure.

18. The vibration control method according to claim 14, wherein the sensing circuit is connected to a sensing layer disposed on the host structure and configured to detect the vibration condition.

19. The vibration control method according to claim 13, wherein the transducer elements comprise discrete piezoelectric devices.

20. The vibration control method according to claim 13, wherein the transducer elements comprise a piezoelectric layer and an electrode layer, and wherein the electrode layer comprises a plurality of electrode segments electrically isolated from each other.

21. The vibration control method according to claim 13, further comprising dissipating, absorbing or cancelling vibration energy based on the single vibration control signal or electrical impedance source provided to the group of interconnected transducer elements.

22. (canceled)

23. The vibration control method according to claim 13, further comprising configuring a parameter of the at least one vibration control circuit.

24. A method of fabricating a vibration control system, the method comprising the steps of:
providing a plurality of spatially distributed transducer elements;
connecting a switching circuit to each of the transducer elements;
connecting each of one or more vibration control circuits to the switching circuit;
connecting the one or more vibration control circuits and the switching circuit to a controller circuit,
programming the controller circuit to control the switching circuit to interconnect selected ones of the transducer elements based on a switching signal provided by the controller circuit, the switching signal being in response to a vibration condition, to adaptively form a group of interconnected transducer elements; and
programming the controller circuit to control the switching circuit to connect the group of interconnected transducer elements to a selected at least one of the one or more vibration control circuits for receiving a single vibration control signal or electrical impedance source corresponding to the vibration condition.

25.-31. (canceled)
